(19) United States
(12) Patent Application Publication
(10) Pub. No.: US 2010/0117611 A1
(43) Pub. Date: May 13, 2010

(54) Regulator circuit having N-type MOS transistor controlled by error amplifier

(75) Inventor: Takashi Yamada, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/588,362

(22) Filed: Oct. 13, 2009

(30) Foreign Application Priority Data
Nov. 10, 2008 (JP) 2008-287407

(51) Int. Cl. G05F 1/10

(52) U.S. Cl. 323/282

(57) ABSTRACT

A regulator circuit includes a direct-current voltage conversion circuit which receives a first power supply voltage, and generates a second power supply voltage by stepping down a first power supply voltage, and an error amplifier that operates based on the first power supply voltage, and outputs an output control signal by comparing a feedback voltage that varies depending on an output voltage outputted from an output terminal and a reference voltage. The regulator circuit includes an N-type MOS transistor including a drain supplied with the second power supply voltage, a source connected to the output terminal, and a gate receiving the output control signal.

### INCORPORATION BY REFERENCE

This application is based upon and claims the benefit of priority from Japanese Patent Application No. 2008-287407 which was filed on Nov. 10, 2008, the disclosure of which is incorporated herein in its entirety by reference.

### BACKGROUND OF THE INVENTION

1. Field of the Invention

The present invention relates to a regulator circuit, and more specifically, to a regulator circuit having a series regulator that operates after receiving a stepped-down voltage that a first stage regulator circuit outputs.

2. Description of Related Art

In recent years, manufacturing processes of the semiconductor device have shifted to microfabrication, and the degree of integration of the semiconductor device is becoming higher. In the semiconductor device, dielectric breakdown voltage of the semiconductor element is reduced by microfabrication of the manufacturing process in the semiconductor device. However, voltage reduction of the power supply voltage of the power supply supplied from the outside has not been progressing. Therefore, if the same power supply voltage as before is supplied to the semiconductor device that is manufactured by a manufacturing process subjected to microfabrication, then a problem becomes obvious that an excessive power supply voltage is applied to a semiconductor element in the semiconductor device and the semiconductor element will be broken.

Thereupon, in recent years, it is practiced that the power supply voltage applied to the semiconductor device is subjected to direct-current voltage conversion to generate a stepped-down voltage, and this stepped-down voltage is supplied to the semiconductor device. In this way, the regulator circuit is used as a circuit for performing voltage conversion when the voltage value of the power supply voltage is converted to a different voltage, which is supplied to another circuit. One example of the regulator circuit is disclosed in Patent Document 1.

The regulator circuit described in Patent Document 1 has an output transistor and a control circuit. In this example, an NPN bipolar transistor is used as the output transistor. Moreover, the control circuit controls continuity of the output transistor by controlling a base current of the output transistor. Then, the regulator circuit described in Patent Document 1 outputs a stepped-down voltage that is stepped down from the external power supply voltage inputted from a collector terminal. However, the regulator circuit described in Patent Document 1 has a problem that, since an NPN transistor is used as the output transistor, a large base current is required in order to obtain a large output current, which deteriorates an electric power efficiency of the regulator circuit. Therefore, in recent years, a regulator circuit that uses a PMOS transistor requiring no base current as the output transistor is proposed in Patent Documents 2 or 3.

Here, Patent Document 2 out of Patent Documents 2 and 3 will be described. FIG. 3 shows a block diagram of a regulator circuit 101 described in Patent Document 2. As shown in FIG. 3, the regulator circuit 101 has a switching regulator 102, a series regulator 103, and a voltage switching control circuit 104. The switching regulator 102 converts the power supply voltage VA outputted from a power supply 107 connected to the outside into an output voltage VB. The series regulator 103 converts the output voltage VB into an output voltage VC, and outputs it.

The voltage switching control circuit 104 has a first delay circuit 111, a second delay circuit 112, and a control circuit 113. The voltage switching control circuit 104 controls timings at which voltage switching signals Sa1, Sa2 are outputted to the switching regulator 102 and the series regulator 103, respectively. At this time, the control circuit 113 outputs a control signal S1 to the first delay circuit 111, and a control signal S2 to the second delay circuit 112, respectively, in response to the voltage switching signal Sa. In response to the inputted control signal S1, the first delay circuit 111 outputs the voltage switching signal Sa1 that is based on the voltage switching signal Sa to the switching regulator 102. In response to the inputted control signal S2, the second delay circuit 112 outputs the voltage switching signal Sa2 that is based on the voltage switching signal Sa to the series regulator 103.

Here, FIG. 4 shows a block diagram of the series regulator 103. As shown in FIG. 4, the series regulator 103 has a reference voltage generating circuit 125, an error amplifier A11, resistances R11 to R14, a switch SW2, and an output transistor Q11. Then, the error amplifier A11 amplifies an error between a reference voltage Vr2 that the reference voltage generating circuit 125 outputs and a feedback voltage that is inputted into an inverting input terminal through the resistances R11, R12 or the resistances R13, R14, and drives the output transistor Q11. By selecting either one group of the resistances R11, R12 and the resistances R13, R14 based on the voltage switching signal Sa2, the switch SW2 gives either one of a feedback voltage Vd11 or a feedback voltage Vd12 to the inverting input terminal of the error amplifier A11. The error amplifier A11 controls the continuity of the output transistor Q11 based on a difference of the reference voltage Vr2 and the feedback voltage.

In the regulator circuit 101 described in Patent Document 2, when lowering the output voltage VC, the output voltage VC is lowered to the series regulator 103, and subsequently the output voltage VB is lowered to the switching regulator 102. On the other hand, when increasing the output voltage VC, the output voltage VB is increased to the switching regulator 102, ad subsequently the output voltage VC is increased to the series regulator 103. By doing such a control, the regulator circuit 101 obtains the output voltage VC with low noise and ripple.

[Patent Document 1] Japanese Patent Application Laid Open No. Hei 7 (1995)-95765.

### [Patent Document 2] Japanese Patent Application Laid Open No. 2003-235250.

### [Patent Document 3] Japanese Patent Application Laid Open No. 2008-86165.

### SUMMARY

However, in a series regulator 103, since a PMOS transistor is used as an output transistor Q11, there is a problem that a loss produced in the output transistor Q11 becomes large. This problem will be explained concretely.

First, expressing an input power of the series regulator 103 by Pin, an output power thereof by Pout, and an internal loss of the output transistor Q11 by Pd, the input power Pin can be expressed by Formula (1).

Pin=Pout+Pd (1)

Moreover, expressing a load current flowing in the load connected to the outside of the series regulator 103 by Io, and the drain current flowing in the output transistor Q11 by Id, the internal loss can be expressed by Formula (2).

$$\begin{matrix}Pd = Pin - Pout \\ = VB \times Id - VC \times Io\end{matrix} \qquad ( 2 )$$

At this time, the drain current Id and the load current Io are expressed by Formula (3), when expressing a current flowing in resistances R11 to R14 by Ix.

Id=Io+Ix

Therefore, the internal loss Pd is expressed by Formula from Formulae (2), (3).

Pd=(VB−VC)Io+VB×Ix (4)

Here, since the current Ix is extremely smaller than the load current Io, if a term including the current Ix is omitted, then the internal loss Pd can be expressed by Formula (5).

Pd=(VB−VC)Io (5)

From Formula (5), in the series regulator 103, the internal loss of the output transistor Q11 becomes large in proportion to a voltage difference of an output voltage VB and an output voltage VC. Therefore, in order to make small the internal loss Pd of the output transistor Q11 in the series regulator 103, it is necessary to make small the difference of the output voltage VB and the output voltage VC. However, when the voltage of the output voltage VB is made small in the series regulator 103, another problem will arise. In the series regulator 103, the PMOS transistor is used as the output transistor Q11. A drain current Id of the PMOS transistor becomes large in proportion to a gate-source voltage difference Vgs. The drain current Id can be expressed by Formula (6).

Id=β/2×(Vgs−Vt)² (6)

Here, Vt is a threshold voltage of the PMOS transistor, β is β=W/L×μCox, W is a gate width of the PMOS transistor, L is a gate length of the PMOS transistor, μ is a mobility of the PMOS transistor, and Cox is a gate oxide film capacity per unit area of a gate of the PMOS transistor.

That is, from Formula (6), in the output transistor Q11, if the voltage of the output voltage VB is lowered, the gate-source voltage difference Vgs will become small, and consequently it becomes impossible to secure a large drain current Id.

From the above-mentioned explanation, it turns out existence of a problem that if a large load current Io is intended to be obtained while the output voltage is being kept low, then the internal loss generated in the output transistor Q11 become large.

A regulator circuit according to an exemplary aspect of the present invention includes a direct-current voltage conversion circuit which receives a first power supply voltage, and generates a second power supply voltage by stepping down the first power supply voltage, and an error amplifier that operates based on the first power supply voltage, and outputs an output control signal by comparing a feedback voltage that varies depending on an output voltage outputted from an output terminal and a reference voltage. The regulator circuit includes an N-type MOS transistor including a drain supplied with the second power supply voltage, a source connected to the output terminal, and a gate receiving the output control signal.

According to the exemplary aspect, the first power supply voltage is supplied to the error amplifier, and the N-type MOS transistor is used for the output transistor. Thereby, even in the case where the output voltage is low, the gate-source voltage difference Vgs of the N-type. MOS transistor can be extended up to the first power supply voltage.

According to the regulator circuit according to the exemplary aspects of the present invention, a low output voltage and a high output current can be realized while making the internal loss in the output transistor small.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a block diagram of a regulator circuit according to a first exemplary embodiment;

FIG. 2 is a block diagram of a regulator circuit according to a second exemplary embodiment;

FIG. 3 is a block diagram of a regulator circuit described in Patent Document 2; and

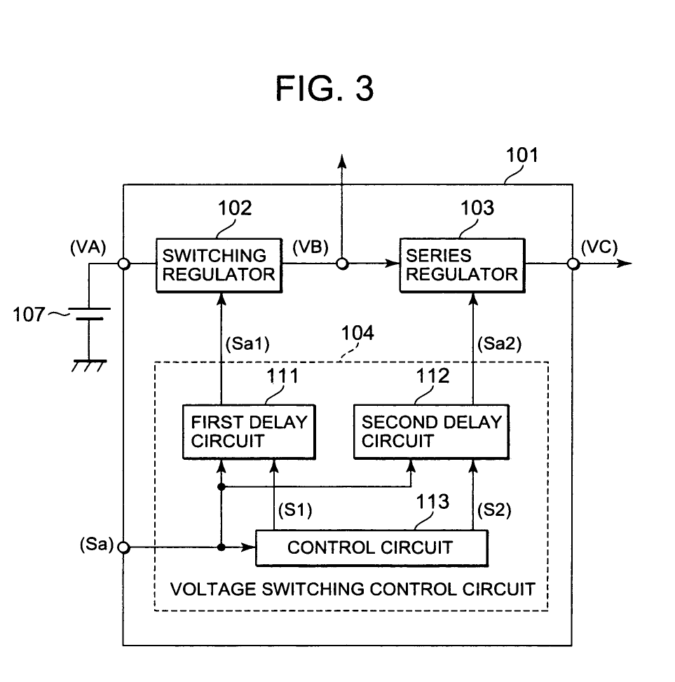

FIG. 4 is a block diagram of a series regulator described in Patent Document 2.

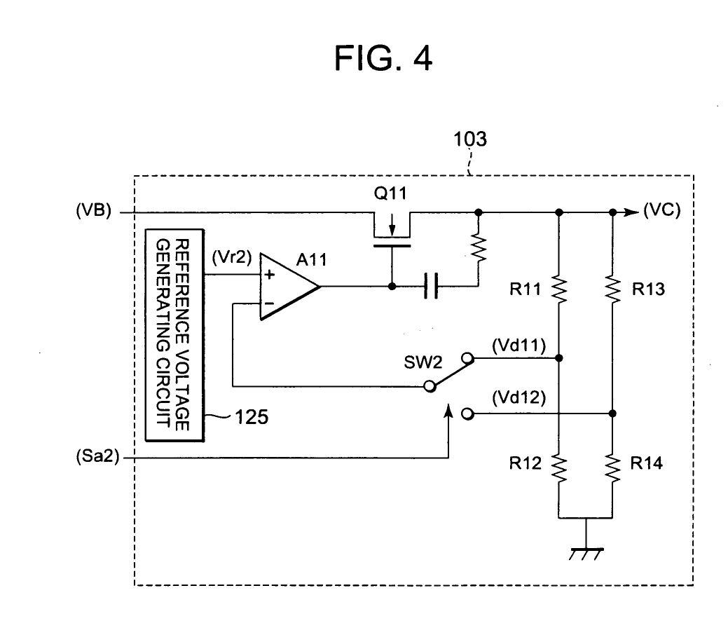

### DETAILED DESCRIPTION OF THE EXEMPLARY EMBODIMENTS

### First Exemplary Embodiment

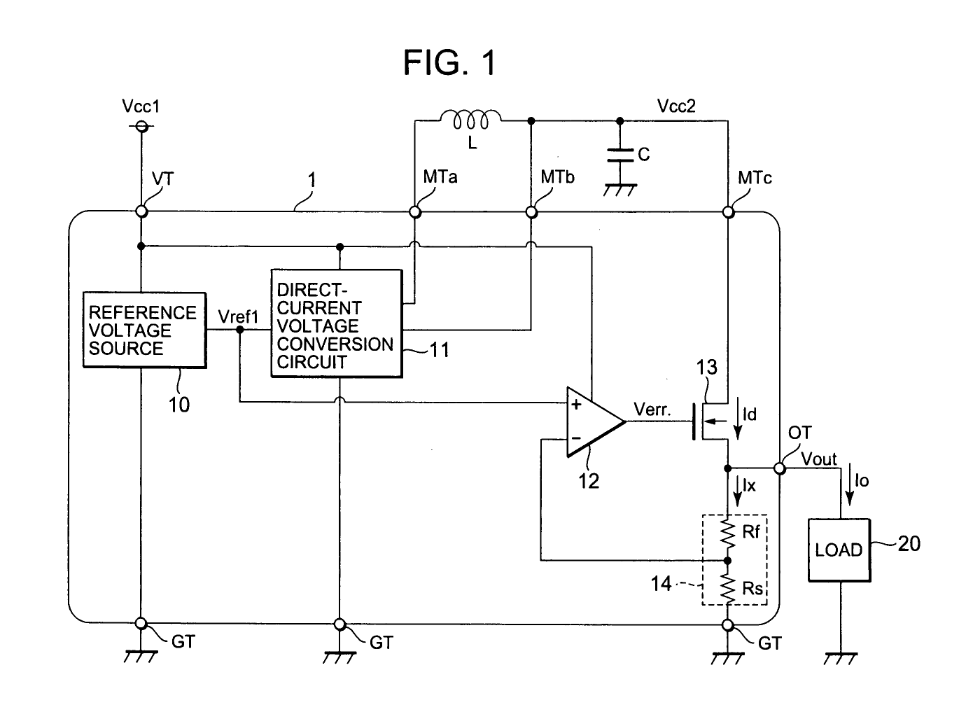

FIG. 1 shows a block diagram of a regulator circuit 1 according to a first exemplary embodiment. As shown in FIG. 1, the regulator circuit 1 has a reference voltage source 10, a direct-current voltage conversion circuit 11, an error amplifier 12, an output transistor 13, a voltage dividing circuit 14, an inductance L, and a capacitor C. In addition, the inductance L and the capacitor C are presupposed to be mounted as external parts. Moreover, a regulator circuit 1 has a power supply terminal VT, external terminals MTa to MTc, an output terminal OT, and ground terminals GT. Although FIG. 1 shows three ground terminals GT, the ground terminal GT may be a single terminal.

The reference voltage source 10 is connected between the power supply terminal VT and the ground terminal GT. In receiving a first power supply voltage Vcc1, the reference voltage source 10 generates a first reference voltage Vref1. The direct-current voltage conversion circuit 11 is connected between the power supply terminal VT and the ground terminal GT. The direct-current voltage conversion circuit 11 generates a second power supply voltage Vcc2 by driving the inductance L connected through the external terminals MTa, MTb and accumulating electric charge in the capacitor C. The direct-current voltage conversion circuit 11 controls a voltage of the second power supply voltage Vcc2 based on the first reference voltage Vref1. Moreover, the direct-current voltage conversion circuit 11 maintains a voltage value of the second power supply voltage Vcc2 by controlling a drive interval at which the inductance L is driven in response to the voltage value of the second power supply voltage Vcc2. That is, the direct-current voltage conversion circuit 11 functions as a switching regulator together with the inductance L and the capacitor C.

In the exemplary embodiment, the error amplifier 12, the voltage dividing circuit 14, and the output transistor 13 constitute a series regulator. The error amplifier 12 operates in response to receiving the first power supply voltage Vcc1 inputted from the power supply terminal VT. Moreover, the error amplifier 12 receives the first reference voltage Vref1 on its non-inverting input terminal, and receives a feedback voltage on its inverting input terminal. Then the error amplifier 12 amplifies a voltage difference of the first reference voltage Vref1 and the feedback voltage, and outputs an output control signal Verr.

The voltage dividing circuit 14 has resistances Rf, Rs that are connected in series between the output terminal OT and the ground terminal GT. Then the voltage dividing circuit 14 outputs the feedback voltage that is obtained by dividing an output voltage Vout based on a resistance ratio of the resistance Rf and the resistance Rs from a node between the resistance Rf and the resistance Rs.

The output transistor 13 is an N-type MOS transistor (hereinafter referred to simply as an NMOS transistor). As for the output transistor 13, its source is connected to the output terminal OT, its drain is connected to the external terminal MTc, and its gate is connected to the output terminal of the error amplifier 12. That is, continuity of the output transistor 13 is controlled based on the output control signal Verr that the error amplifier 12 outputs. Moreover, the output transistor 13 receives the second power supply voltage Vcc2 through the external terminal MTc. Then the output transistor 13 outputs the output voltage Vout to the output terminal OT based on the output control signal Verr.

A load 20 is connected to the output terminal OT. The output voltage Vout generated by the regulator circuit 1 is applied to this load 20. Moreover, a load current Io is supplied to the load 20 through the regulator circuit 1. A maximum of the load current Io is determined by a current capability of the output transistor 13.

Next, an operation of the regulator circuit 1 according to the exemplary embodiment will be explained. First, the first reference voltage Vref1 is presupposed to be a stable voltage to a voltage variation of the first power supply voltage Vcc1 and a temperature variation. Moreover, the second power supply voltage Vcc2 is presupposed to be a lower voltage than the first power supply voltage Vcc1. That is, the switching regulator including the direct-current voltage conversion circuit 11 is presupposed to function as a switching regulator of a stepping down type.

At this time, since the power supply voltage supplied to the error amplifier 12 is the first power supply voltage Vcc1, the output control signal that the error amplifier 12 outputs has a voltage variation range from the ground voltage (e.g., 0 V) to the first power supply voltage Vcc1. Therefore, a gate-source voltage difference Vgs of the output transistor (NMOS transistor) 13 becomes Vout−Vcc1, and the drain current Id of the NMOS transistor 13 is expressed by Formula (7).

Id=β/2×(Vgs−Vt)² (7)

Here, Vt is a threshold voltage of a PMOS transistor, β is β=W/L×μCox, W is a gate width of the PMOS transistor, L is a gate length of the PMOS transistor, μ is a mobility of carriers of the PMOS transistor, and Cox is a gate oxide film capacity per unit area of a gate of the PMOS transistor.

When the NMOS transistor is used as the output transistor 13, the gate-source voltage difference Vgs is dependent on the output voltage Vout, while not dependent on the second power supply voltage Vcc2 supplied to the drain of the NMOS transistor. Therefore, from Formula (7), it is possible to enlarge the drain current Id that flows in the output transistor 13 of the regulator circuit 1, being independent of the voltage value of the second power supply voltage Vcc2.

Moreover, expressing the input power of the output transistor 13 by Pin, the output power by Pout, and an internal loss of the output transistor 13 by Pd, the input power Pin can be expressed by Formula (1).

Pin=Pout+Pd (8)

Expressing the load current flowing in the load 20 connected to the outside of the regulator circuit 1 by Io, and the drain current flowing in the output transistor 13 by Id, the internal loss Pd is expressed by Formula (9).

$$\begin{matrix}Pd = Pin - Pout \\ = Vcc 2 \times Id - Vout \times Io\end{matrix} \qquad ( 9 )$$

At this time, expressing a current flowing in the resistances Rf, Rs by Ix, Id and Io are expressed by Formula (10).

Id=Io+Ix

Therefore, the internal loss Pd is expressed by Formula (11) from Formulae (9), (10).

Pd=(Vcc2−Vout)Io+Vcc2×Ix (11)

Here, since the current Ix is extremely small compared with the load current Io, the internal loss Pd is expressed by Formula (12) if a term including the current Ix is omitted.

Pd=(Vcc2−Vout)Io (12)

From Formula (12), in the regulator circuit 1, the internal loss of the output transistor 13 becomes large in proportion to a voltage difference of the output voltage Vout and the second power supply voltage Vcc2. Therefore, in order to make the internal loss small, it is necessary to make small the value of the second power supply voltage Vcc2. At this time, since in the regulator circuit 1, the current capability of the output transistor 13 (drain current Id value) is not affected the second power supply voltage Vcc2, even if the second power supply voltage Vcc2 is made close to the output voltage Vout, the current capability of the output transistor 13 will not lower.

From the above explanation, the regulator circuit 1 according to the exemplary embodiment can determine the output current capability of the output transistor 13 by using a MOS transistor as the output transistor 13, being independent of the voltage value of the second power supply voltage Vcc2. Thereby, the regulator circuit 1 can reduce the internal loss of the output transistor 13 by lowering the voltage value of the second power supply voltage Vcc2, while maintaining the output current capability of the output transistor 13.

Moreover, the regulator circuit 1 can set large the gate-source voltage difference Vgs of the NMOS transistor by supplying the first power supply voltage Vcc1 to the error amplifier 12. That is, even when the output voltage Vout is a value close to the voltage value of the second power supply voltage Vcc2, the output control signal Verr can be made to be a value close to the first power supply voltage Vcc1. Thereby, the regulator circuit 1 can enhance the current capability of the output transistor 13 being independent of the voltage value of the output voltage Vout.

Moreover, in the regulator circuit 1, being in series to the switching regulator including the direct-current voltage conversion circuit 11, the series regulator including the error amplifier 12 and the output transistor 13 is disposed. In the regulator circuit 1, this can inhibit an influence of noise components, such as the switching noise and a rip noise, that are superimposed on the second power supply voltage Vcc2 from affecting the output voltage Vout. Since a circuit that is connected as the load 20 operates based on a small range of the power supply voltage, reducing the influence of the noise becomes very important to stabilize the operation of the load circuit.

### Second Exemplary Embodiment

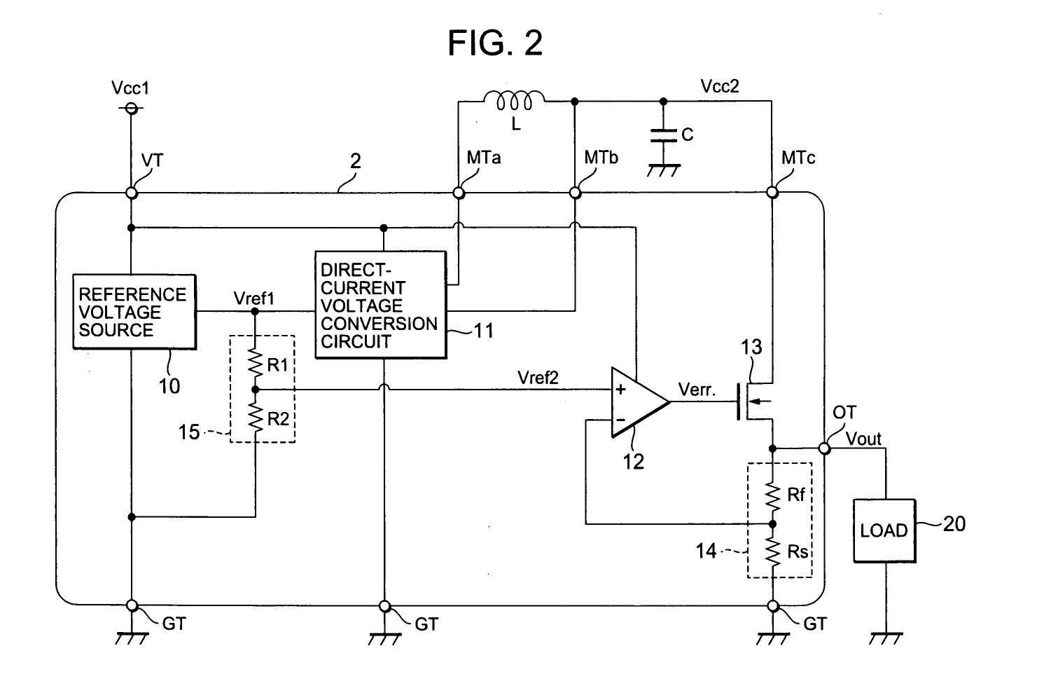

FIG. 2 shows a block diagram of a regulator circuit 2 according to a second exemplary embodiment. As shown in FIG. 2, the regulator circuit 2 is the regulator circuit 1 with a reference voltage conversion circuit 15 added thereto. The reference voltage conversion circuit 15 is connected between an output terminal of the reference voltage source 10 and the ground terminal GT. Moreover, the reference voltage conversion circuit 15 has the resistances R1, R2 that are connected in series between the output terminal of the reference voltage source 10 and the ground terminal GT. The reference voltage conversion circuit 15 receives the first reference voltage Vref1 to one end of the resistance R1, and divides the first reference voltage Vref1 based on the resistance ratio of the resistances R1, R2. Then, the reference voltage conversion circuit 15 outputs a second reference voltage Vref2 generated by the resistances R1, R2. That is, the second reference voltage Vref2 has a lower voltage value than the first reference voltage Vref1. The second reference voltage Vref2 is inputted into the non-inverting input terminal of the error amplifier 12. The series regulator including the error amplifier 12 controls the voltage value of the output voltage Vout based on the second reference voltage Vref2.

In the regulator circuit 1 according to the first exemplary embodiment, since the error amplifier 12 constitutes a non-inverting amplifier, the regulator circuit 1 was unable to output the output voltage Vout lower than the first reference voltage Vref1. Thereupon, in the second exemplary embodiment, the reference voltage that is given to the error amplifier 12 is set to the second reference voltage Vref2 having a smaller voltage value than the first reference voltage Vref1. Thereby, the regulator circuit 2 according to the second exemplary embodiment can output a lower output voltage Vout than the first reference voltage Vref1.

In the regulator circuit 1 according to the first and second exemplary embodiments, even when the output voltage Vout is set low, the current capability of the output transistor (NMOS transistor) 13 is not impaired, but is improved rather. Therefore, by making the output voltage Vout low by a method as shown in the second exemplary embodiment, the regulator circuit 2 can respond to a larger load current Io than the regulator circuit 1 does. Note that, when the output voltage Vout is made low, it is desirable to lower the voltage of the second power supply voltage Vcc2 according to a fall of the output voltage Vout. This is for reducing the internal loss of the output transistor 13.

Note that the present invention is not restricted to the above-mentioned exemplary embodiments, but can be suitably changed and modified within a scope that does not deviate from the spirit of the invention. For example, the generator regulator disposed in a first stage is not limited to the switching regulator, but it is possible to dispose various direct-current voltage conversion circuits.

Further, it is noted that Applicant's intent is to encompass equivalents of all claim elements, even if amended later during prosecution.

What is claimed is:

1. A regulator circuit, comprising:
a direct-current voltage conversion circuit which receives a first power supply voltage, and generates a second power supply voltage by stepping down the first power supply voltage;
an error amplifier that operates based on the first power supply voltage, and outputs an output control signal by comparing a feedback voltage that varies depending on an output voltage outputted from an output terminal and a reference voltage; and
an N-type MOS transistor including a drain supplied with the second power supply voltage, a source connected to the output terminal, and a gate receiving the output control signal.

2. The regulator circuit according to claim 1,
wherein the direct-current voltage conversion circuit includes a switching regulator.

3. The regulator circuit according to claim 1,
wherein the output control signal varies in a voltage range whose upper limit voltage is set to the first power supply voltage and whose lower limit voltage is set to the output voltage.

4. The regulator circuit according to claim 1, further comprising:
a voltage dividing circuit including first and second resistances that are connected in series between the output terminal and a ground terminal,
wherein the voltage dividing circuit generates the feedback voltage by dividing the output voltage based on a resistance ratio of the first and second resistances.

5. The regulator circuit according to claim 1,
wherein the reference voltage has a voltage value obtained by dividing a second reference voltage, having a voltage value different from the reference voltage, by a predetermined ratio.

6. A regulator circuit, comprising:
a reference voltage source, connected between a first power source terminal receiving a first power source voltage and a second power source terminal receiving a second power source voltage, to produce a reference voltage;
a direct-current voltage conversion circuit connected between the first and second power source terminals;
a third power source terminal which receives a third power source voltage produced by an output of the direct-current voltage conversion circuit, an inductor and a capacitor;
an error amplifier which is connected to the first power source terminal, and produces a control signal based on the reference voltage and a feedback voltage;
an N-type MOS transistor connected between the third power source terminal and an output terminal, the N-type MOS transistor including a gate electrode supplied with the control signal; and
a voltage divider connected between the output terminal and the second power source terminal, to produce the feedback voltage.

7. The regulator circuit as claimed in claim 6, wherein the reference voltage is a first reference voltage, the regulator circuit further comprising:
a second voltage divider which produces a second reference voltage based on the first reference voltage,
wherein the error amplifier receives the second reference voltage as the reference voltage.

8. A series regulator, comprising:
an error amplifier which produces a control signal based on a reference voltage and a feedback voltage;
an N-type MOS transistor connected between a first terminal and an output terminal, the N-type MOS transistor including a gate electrode supplied with the control signal; and
a voltage divider connected between the output terminal and a second terminal, to produce the feedback voltage.
